(19) United States
(12) Patent Application Publication
(10) Pub. No.: US 2005/0187805 A1
(43) Pub. Date: Aug. 25, 2005

(54) Application-driven scheduling system and method

(75) Inventor: Jason R. English, Dallas, TX (US)

Correspondence Address: i2 TECHNOLOGIES US, INC., ONE i2 PLACE, 11701 LUNA ROAD, DALLAS, TX, 75234, US

(73) Assignee: i2 TECHNOLOGIES US, INC.

(21) Appl. No.: 11/109,346

(22) Filed: Apr. 19, 2005

Related U.S. Application Data
(63) Continuation of application No. 09/675,407, filed on Sep. 29, 2000, now abandoned.

(51) Int. Cl. G06F 17/60

(52) U.S. Cl. 705/8

(57) ABSTRACT

An application-driven scheduling system (10) includes a scheduling engine (18) that receives at least one schedule item (34) and associated time information from at least one application (12). The scheduling engine (18) determines whether the time information for the item (34) satisfies one or more schedule criteria and, if so, determines a location (44) for the item (34) within a schedule (30) according to the time information. The scheduling engine (18) generates the schedule (30) containing the item (34) and a rendering engine (20) renders the schedule (30) for display to at least one user (14). The schedule (30) may include one or more cells (38), with the location (44) for the item (44) being in a particular cell (38), the scheduling engine (18) determining the location (44) for the item (34) within the cell (38) according to the time information based on a percentage of the width (42) of the cell (38). The item (34) may be incorporated into the schedule (30) dynamically in response to its generation at the application (12).

### TECHNICAL FIELD OF THE INVENTION

This invention relates in general to computer-implemented scheduling systems and more particularly to an application-driven scheduling system and method.

### BACKGROUND OF THE INVENTION

Individual and business users often rely on electronic scheduling applications to help plan and organize personal and business activities over various time horizons. For example, an individual might use an electronic calendar application to schedule tasks, meetings, appointments, and the like. Similarly, a project manager in a business might use an application that generates Gantt charts to schedule various project tasks, phases, and associated due dates. Such applications typically require a user to manually input items to be scheduled (at least once even for recurring items), require fairly extensive memory and processing overhead, and cannot be readily incorporated into the software associated with a web server so as to be available to multiple users over the Internet or business intranet.

If scheduling software is associated with a website, such as an intranet website associated with a distributor of goods, the software will typically merely support a text listing or text spreadsheet of application-generated schedule items. For example, such software might generate a list of purchase orders received, a list of the orders fulfilled, and a list of alerts. Such lists are often difficult for personnel to meaningfully interpret and address, if necessary, particularly where such business activity occurs rapidly and substantially continuously during the business day. If corresponding graphics are to be generated in an effort to make this information more accessible to personnel, relatively heavy server-side processing and rendering logic, proprietary graphics tools, and other capabilities are typically required. Even when they can be generated, such graphics are often difficult for unsophisticated users to interpret, may require excessive scrolling or other manipulations due to their size in relation to browser windows of the users, and may have other deficiencies. Any one of these or other disadvantages are sufficient to make previous scheduling techniques inadequate for the needs of many users.

### SUMMARY OF THE INVENTION

According to the present invention, problems and disadvantages associated with previous scheduling techniques are substantially reduced or eliminated.

According to one embodiment, an application-driven scheduling system includes a scheduling engine that receives at least one schedule item and time information for the item from at least one application. The scheduling engine determines whether the time information for the item satisfies one or more schedule criteria and, if so, determines a location for the item in a schedule according to the time information. The scheduling engine generates the schedule containing the item and a rendering engine renders the schedule for display to at least one user. In a more particular embodiment, the schedule may include one or more cells, where the location for the item is in a particular cell, the scheduling engine determining the location for the item within the cell according to the time information based on a percentage of the width of the cell. In another particular embodiment, the item may be incorporated into the schedule dynamically in response to its generation at the application.

The present invention provides a number of technical advantages over previous techniques. The present invention allows an application-driven schedule to be generated dynamically in response to events, alerts, or other schedule items received from one or more applications. The items and associated information may be generated on the fly from within virtually any planning, business, or other workflow, without requiring the extensive processing overhead, memory, bandwidth, and other resources often required with prior scheduling systems. A schedule may be generated as part of a web page in Hypertext Markup Language (HTML) format, such that any authorized user having an HTML-enabled front end may view the schedule, without necessitating an embedded client-side interface or proprietary graphics tools.

The schedules generated according to the present invention allow one or more simultaneous users to more readily identify, interpret, and appreciate the significance of events, alerts, and other schedule items, such that a user may better plan, organize, and respond to such items. The user may be able to brush over images associated with the items to obtain overview information or click on such images to obtain more detailed information, perhaps enabling problem-resolution or other item-related activities from within the schedule. These schedules may also be readily customized, personalized, or otherwise modified according to particular needs.

Systems and methods incorporating one or more of these or other advantages are well suited for modern scheduling environments such as those associated with Internet websites or electronic marketplaces, business intranets, and various other environments. Other technical advantages will be readily apparent to those skilled in the art from the following figures, descriptions, and claims.

### BRIEF DESCRIPTION OF THE DRAWINGS

FIG. 1 illustrates an exemplary application-driven scheduling system; and

FIG. 2 illustrates an exemplary weekly schedule;

FIG. 3 illustrates an exemplary daily schedule;

FIG. 4 illustrates an exemplary cell of a schedule;

FIG. 5 illustrates exemplary syntax for incorporating an exemplary schedule item into a schedule; and

FIG. 6 illustrates an exemplary method of generating an application-driven schedule.

### DETAILED DESCRIPTION OF THE INVENTION

FIG. 1 illustrates an exemplary scheduling system 10 that interacts with one or more applications 12 to generate flexible application-driven schedules accessible to one or more users 14. Applications 12 may include any suitable software applications capable of generating items to be incorporated in schedules, for example, events, alerts, due dates, appointments, meetings, tasks, or any other appropriate schedule items. For example only and without limitation, a particular application 12 may include a demand planner, capacity planner, or other suitable supply chain planning engine. Associated schedule items might include, as examples, an event indicating a purchase order was received, an event indicating an order was fulfilled, a due date indicating the promised date for fulfillment of the order, and an alert indicating the promised date has passed without order fulfillment. Users 14 may be any suitable entities that access schedules generated at system 10, either autonomously or according to input from one or more associated persons. For example, user 14 may be the shipping manager for a distributor of goods who periodically accesses schedules to readily determine which orders are in process, which orders are overdue, and other information that may be pertinent to the responsibilities of user 14.

Applications 12 and users 14 are coupled to system 10 using links 16 that each include one or more local area networks (LANs), metropolitan area networks (MANs), wide area networks (WANs), a global computer network such as the Internet, or other wireline, wireless, or other suitable links. In one embodiment, the system 10 may be associated with an electronic business-to-business (“B2B”) marketplace that facilitates B2B transactions between users 14 over the Internet. According to activities of these users 14, system 10 may access one or more applications 12 to retrieve information that the system 10 makes available to users 14 in the form of application-driven schedules. System 10 may communicate schedules to users 14 in the form of Hypertext Markup Language (HTML) pages, Extensible Markup Language (XML) pages, or in any other scripted page or other suitable format. Although HTML pages are primarily described, the present invention contemplates any appropriate page, file, document, or other data representation. Therefore, where appropriate, references to a page or pages should be construed to encompass all such representations and should not be construed as limiting the scope of the invention to any particular representation. Furthermore, reference to a page is intended to include the displayed image of the page (in a browser window for example) in addition to underlying HTML or other code used to generate the displayed image, where appropriate.

In one embodiment, system 10 includes a scheduling engine 18 that receives a schedule request from a user 14, obtains information from one or more applications 12 used in generating the requested schedule, and generates the content for the requested schedule accordingly. A rendering engine 20 formats the schedule content generated at scheduling engine 18 into an HTML or other page for communication to the user 14. Although the page might include only a displayed image and associated code for one schedule, the page will typically include one or more other elements in addition to the schedule (including its displayed image and associated code). For example, a page that contains a schedule for the shipping manager discussed above might provide additional useful information to the manager outside the region that the schedule occupies. Web server 22 pushes the page containing the requested schedule, as generated according to operations of scheduling engine 18 and rendering engine 20, to user 14. The schedule request from user 14 may specify one or more suitable parameters to control content, appearance, or other features of the requested schedule. For example, the request might restrict the schedule to a particular time period.

In one embodiment, the user 14 may be required to communicate a Hypertext Transfer Protocol (HTTP) request to web server 22 each time user 14 wants to receive a page containing a schedule. The HTTP request identifies a stored page containing the desired schedule using a uniform resource locator (URL) or other appropriate address within the HTTP request. A schedule, and thus any pages containing the schedule, may be updated substantially continuously as applications 12 interact with scheduling engine 18, periodically based upon interactions between applications 12 and scheduling engine 18 in a preceding period, or in any other suitable manner. In response to the user 14 connecting to web server 22 through the HTTP request, the web server 22 retrieves the identified page (rendered for display using rendering engine 20) and communicates the page to user 14, where an associated web browser displays the page for viewing. To receive a more recently generated schedule, user 14 would in this embodiment need to communicate another HTTP request to web server 22.

In another embodiment, a user 14 may support software suitable to provide the functionality of scheduling engine 18 and rendering engine 20, making HTTP requests from user 14 to web server 22 unnecessary. Instead, applications 12 may communicate information directly to user 14 to allow user 14 to generate a schedule and display the schedule in the form of a page or otherwise. For example, software associated with a user 14 might generate and display the schedule in the form of a “pop-up” window not associated with any HTML or other scripted page. The schedule may be updated with information from applications 12 substantially continuously, periodically, or in another manner. Although the applications 12 are described as the primary drivers of schedule content, the present invention contemplates user 14 providing any information to drive schedule content instead of or in addition to applications 12, according to the particular needs and capabilities present.

Applications 12, users 14, and system 10 are each associated with one or more computer systems at one or more locations. The computer systems may each include a suitable input device, such as a keypad, mouse, touch screen, microphone, or any other device to receive input. Each may include an output device that conveys information associated with the operation of system 10, such as visual, audio, or data information. Each may include storage media such as hard disks, “floppy” diskettes, CD-ROMs, or other media to receive input and provide output. Each computer system may further include one or more processors and associated memory to execute instructions and to manipulate information according to operations of system 10. An application 12 may share one or more computer systems or any other resources with other applications 12, one or more components of system 10, or one or more users 14. Similarly, each user 14 may share one or more computer systems or other resources with other users 14, one or more components of system 10, or one or more applications 12. In one embodiment, scheduling engine 18, rendering engine 20, and web server 22 share a server computer system associated with a website, electronic marketplace, or other location accessible to multiple users 14. Although discussed as being separate components, scheduling engine 18, rendering engine 20, and web server 22, or a combination of two or more of these components, may be implemented in whole or in part using a single program, module, application, or other software component.

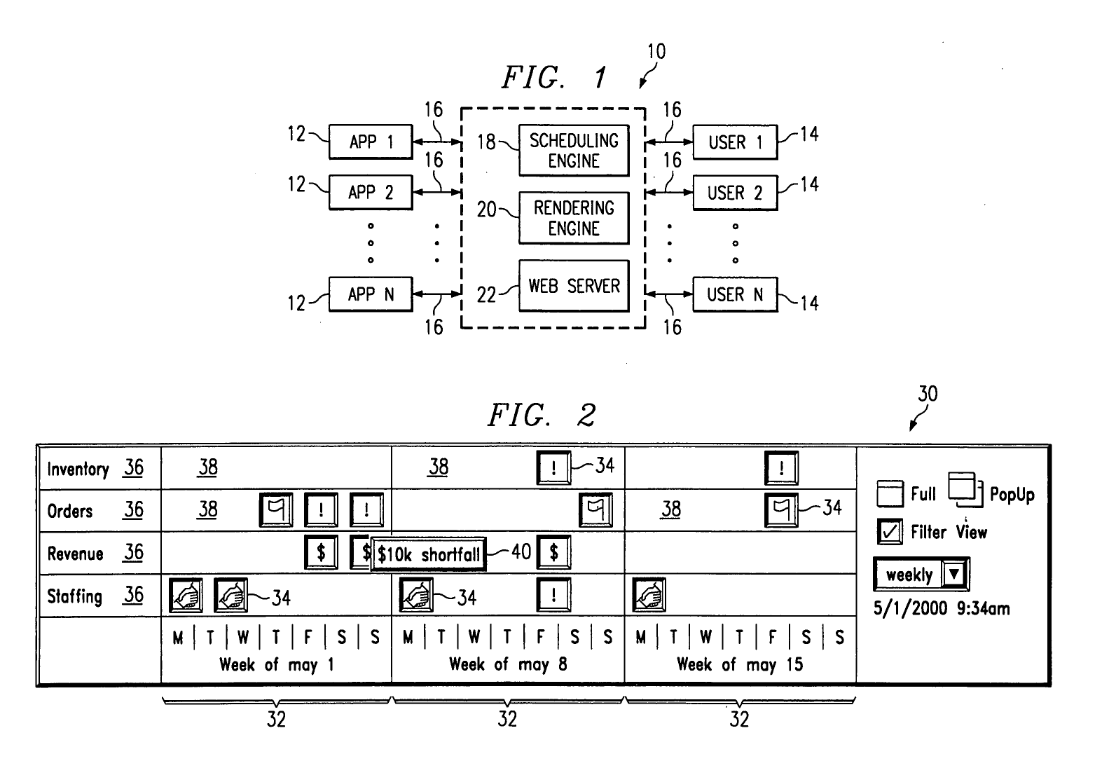

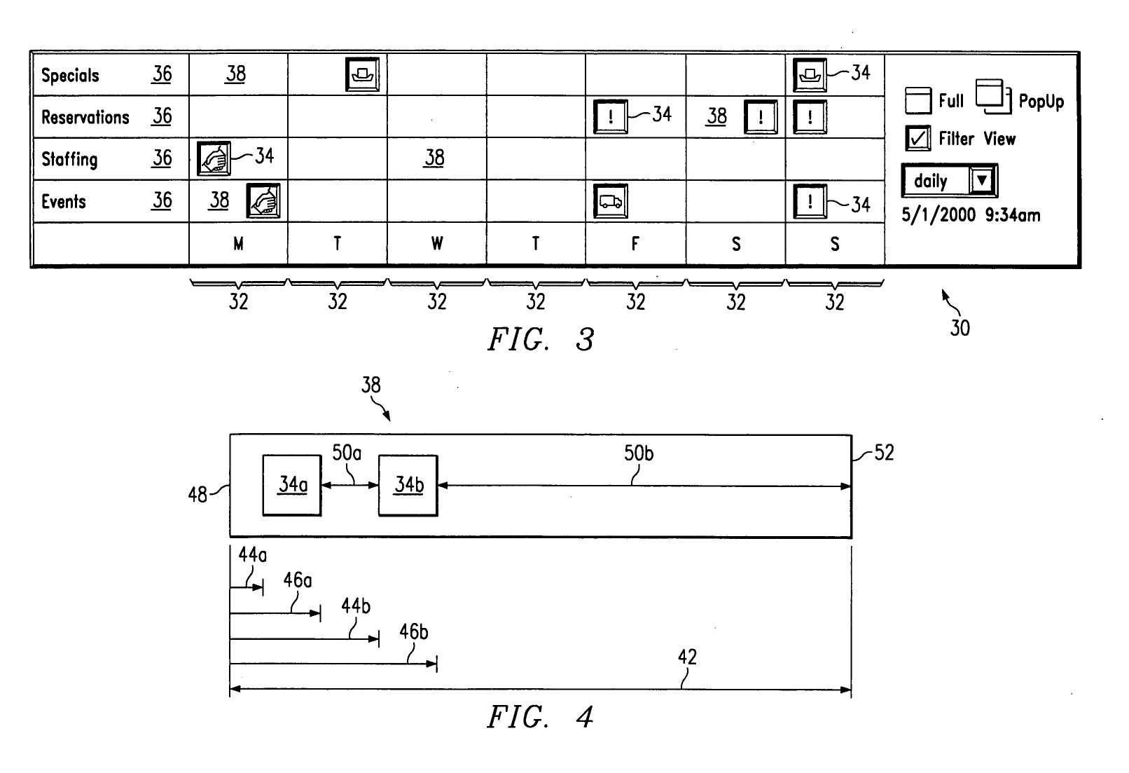

FIG. 2 illustrates an exemplary weekly schedule 30 that system 10 might generate in response to a request from a user 14 and according to information obtained from one or more applications 12. Schedule 30 spans one or more time periods 32 (in this case weeks) and may include one or more schedule items 34 within each of one or more categories 36. Each intersection of a time period 32 with a category 36 defines a corresponding schedule cell 38 in which one or more items 34 may be presented to the user 14. Although schedule 30 is shown as substantially rectangular with substantially rectangular cells 38, the present invention contemplates schedule 30 and its constituent cells 38 having any appropriate configuration. As an example, it might be desirable in some cases to provide a substantially circular schedule 30 with “pie-shaped” cells 38. FIG. 3 illustrates an exemplary daily schedule 30, analogous to the weekly schedule 30 illustrated in FIG. 2 but spanning one or more days 32 and relating to another business (in this case an exemplary restaurant business). The time, date, or both time and date for an item 34 may be referred to as time information for the item 34.

According to the present invention, schedule items 34 may be incorporated in schedule 30 according to any appropriate criteria. In one embodiment, a user 14 may specify one or more periods 32 to which schedule 30 is to be limited. An item 34 will therefore be incorporated into the schedule 30 only if the item 34 occurs or is otherwise associated with one of the specified periods 32. For example, as shown in FIG. 2, when schedule 30 spans three weeks 32 beginning with the week of May 1, 2000, only items 34 that occur in or are otherwise associated with one of these three weeks 32 will be incorporated in schedule 30. The scheduling engine 18 may determine the time and date associated with an item 34 according to information received from one or more applications 12. A user 14 may increase or decrease the number of periods 32, or the length of the individual periods 32 to cause more or fewer items 34 to be displayed in schedule 30. Analogously, user 14 may specify the categories 36 to which schedule 30 will be limited. An item 34 would not be incorporated in schedule 30 if it did not fall within one of the specified categories 36. As described above, the user 14 may need to communicate a new HTTP request to receive the expanded or contracted (in time, with respect to categories 36, or otherwise) schedule 30. Alternatively, user 14 might be able to modify the schedule 30 in substantially real time, for example, if the schedule 30 is displayed as a pop-up window generated using software running at user 14.

User 14 may specify one or more thresholds to customize schedule 30. In one embodiment, these thresholds must be crossed before corresponding items 34 will be incorporated in schedule 30. As an example, an alert item 34 might be associated with inventory levels dropping below a specified threshold. The alert item 34 will not be incorporated unless and until the specified threshold is crossed. When the threshold is crossed, an application 12 may communicate this fact to scheduling engine 18 and the corresponding item 34 may be incorporated in schedule 30. Such alert items 34 might vary according to severity. For example, a warning alert item 34 may be generated in response to inventory levels dropping below a first specified threshold, while a severe alert item 34 might be generated in response to inventory levels dropping to zero (the second specified threshold). The present invention contemplates any suitable criteria to control the incorporation of items 34 into schedule 30 and the appearance of items 34 within schedule 30.

A schedule item 34 may be represented in a schedule 30 using any appropriate Graphics Interface Format (GIF) file or other suitable image. For example, and not by way of limitation, a flag image may represent an event item 34 (e.g., purchase order received), a checkmark image may represent a due date item 34 (e.g., promised delivery date), a yellow exclamation point image may represent a warning alert item 34 (e.g., inventory levels dropping below a first threshold), a red exclamation point image may represent a severe alert item 34 (e.g., inventory levels dropping below a second lower threshold), a handshake image may represent a meeting or appointment item 34, and a dollar sign image may be used to represent a financial or budget related item 34. Any suitable images may be used according to particular needs. Items 34 of the same type may be distinguished from one another according to the color, shape, size, or another suitable characteristic of their respective images. The images of items 34 are preferably customizable, being selected from a pull-down menu for example, according to industry-specific, culture-specific, or other particular needs.

An image may include information obtained from one or more applications 12, further distinguishing the corresponding item 34 from other items 34 and more readily conveying associated information to the user 14. For example, a “PO-38” image may indicate that the purchase order for “Order 38” was received, an “OF-38” image may indicate that the “Order 38” was fulfilled, a yellow “!-38” image may indicate that the promised delivery date for “Order 38” has passed without fulfillment, and a red “!-38” icon may indicate that the promised date passed a specified number of days ago and fulfillment still has not occurred. In one embodiment, in response to user 14 rolling a mouse pointer over (“brushing”) an item 34, pointing to item 34 on a touch screen, or otherwise selecting the item 34, an HTML alt tag or another appropriate statically or dynamically driven element 40 may be displayed over, instead of, or in association with the selected item 34. For example, if a warning alert item 34 has been incorporated into schedule 30 in response to inventory levels dropping below twenty units, an associated alt tag element 40 may display a text message stating “Inventory below 20 units” when user 14 selects the item 34. The user 14 may be able to click on or otherwise select an item 34 to obtain more detailed information concerning the item 34, perhaps enabling problem-resolution or other item-related activities from within the schedule 30. While HTML alt tags are primarily described, the present invention contemplates any element 40 to convey information in response to selection of an associated item 34.

System 10 may generates schedules 30 in connection with any suitable business or other endeavor. For example, as described above, schedule 30 may relate to on-line or other order processing and fulfillment operations. More broadly, schedule 30 may relate to any suitable supply chain planning activity. As an example, schedule 30 may allow factory planning personnel to readily identify supply, capacity, or other shortages over a specified time periods 32, possibly across multiple manufacturing operations within a factory or even across multiple factories, and then drill down using element 40 to obtain additional information concerning the shortages. As another example, schedule 30 may relate to operations of a public utility and allow field maintenance personnel to readily identify appointments, determine their nature and urgency, and drill down using element 40 to obtain additional information associated with a specific job ticket. As yet another example, schedule 30 may allow a restaurant manager to readily identify overbookings, staffing shortages, and inventory shortages and respond accordingly. As still another example, schedule 30 may allow an on-line consumer to readily identify anniversaries, birthdays, and other events and then select a link within the associated page to access a preferred website for the person associated with the event. Those skilled in the art will appreciate that these are merely exemplary uses of schedules 30. Schedules 30 may be used in any suitable context without departing from the intended scope of the present invention.

In one embodiment, each schedule item 34 (assuming it satisfies the criteria for incorporation in schedule 30) is first associated with an appropriate cell 38 based on the time period 32 with which the item 34 is associated. For example, if an event item 34 will occur on May 3, 2000 and schedule 30 includes three weeks 32 beginning with the week 32 of May 1, 2000, item 34 may be placed in cell 38 for the week 32 of May 1, 2000. Similarly, if an event item 34 will occur at 10:00 a.m. on May 3, 2000 and the schedule 30 includes seven days 32 beginning with May 1, 2000, the item 34 may be placed in cell 38 for May 3, 2000. The placement of item 34 within its appropriate cell 38 may be determined based on the date (within a weekly time period 32) or the time (within a daily time period 32) associated with item 34 in relation to a percentage of the horizontal width of cell 38.

For example, referring to FIG. 4, given a cell 38 of horizontal width 42 that spans the time period 32 between 8:00 a.m. and 6:00 p.m., an event item 34a may occur at 8:18 a.m. (eighteen minutes or three percent into time period 32). Scheduling engine 18 would therefore generate item 34a for placement at a location 44a, three percent of horizontal distance 42 into the cell 38. In one embodiment, a location 44 specifies the amounts by which the left-most pixel of a corresponding item 34 is separated from the left edge 48 of cell 38, although any suitable frame of reference may be used without departing from the intended scope of the present invention. Similarly, event item 34b may occur at 10:00 a.m. (two hours or twenty percent into time period 32). Therefore, scheduling engine 18 would generate item 34b for placement at a location 44b, twenty percent of horizontal distance 42 into the cell 38. Empty space, or any other space not dedicated to an item 34, may be similarly specified or may be inferred according to the locations 44 for adjacent items 34 or boundaries of cell 38. For example, a space 50a between first item 34a and second item 34b might be specified according to a location 46a, and a space 50b between second item 34b and the right edge 52 of cell 38 may be specified according to a location 46b.

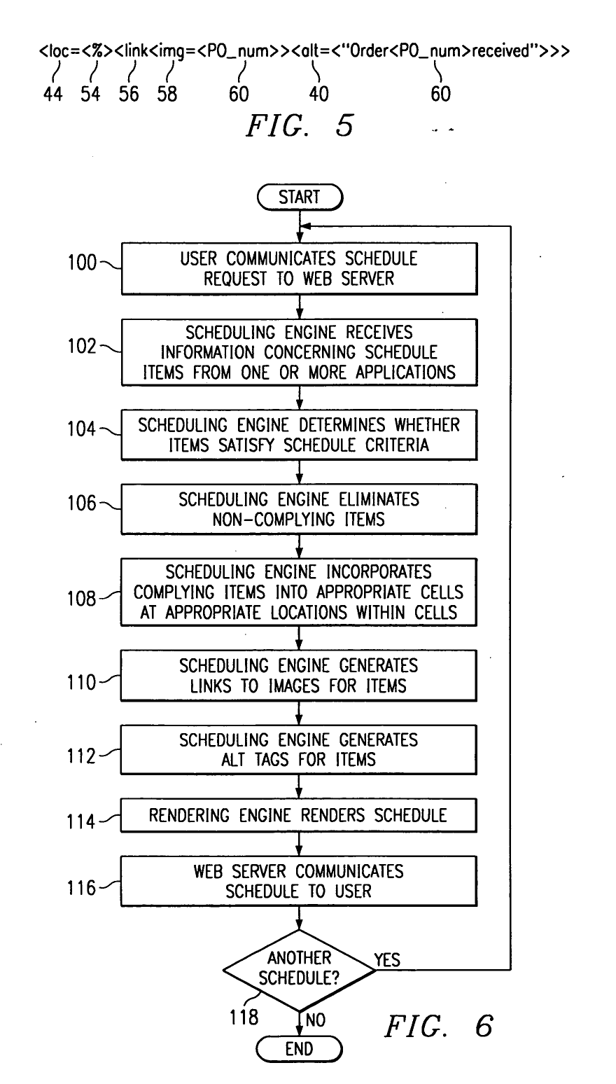

In one embodiment, the above may be accomplished for an exemplary item 34 within schedule 30 using the syntax illustrated in FIG. 5 (which is not intended to correspond with the precise syntax of HTML or any other programming language). In this example, for a purchase order received item 34, scheduling engine 18 obtains time information from an appropriate application 12 and specifies a location 44 according to this time information as a percentage 54 of horizontal width 42 for the appropriate cell 38. A link 56 allows scheduling engine 18, rendering engine 20, or another component of system 10 to retrieve the appropriate GIF or other image 58 for item 34, which as described above will be incorporated in schedule 30 according to location 44. In this example, image 58 may incorporate a purchase order number or other identifier 60, as shown, which may also be obtained from the application 12. Alternatively, image 58 may be the same for every purchase order received item 34, with the particular order number for each item 34 being provided using an associated alt tag 40. Alt tag 40 for exemplary item 34 displays a text message that the particular purchase order has been received, the purchase order number being obtained from application 12. Using this general syntax, or any other suitable syntax, system 10 is able to generate schedule 30 incorporating one or more items 34 in a flexible and application-driven manner. The syntax preferably provides standard HTML commands that may be processed using a standard HTML parser and displayed using any HTML-enabled web browser or other front end.

FIG. 6 illustrates an exemplary method of generating an application-driven schedule 30. The method is described with system 10 being separate from users 14 and applications 12, such as where system 10 operates in connection with a website, on-line electronic marketplace, or other suitable location. However, as described above, one or more components of system 10, such as scheduling engine 18 and rendering engine 20, may be integral to the user 14 and may operate accordingly without departing from the intended scope of the present invention. The method begins at step 100, where user 14 communicates a schedule request to web server 22. In one embodiment, the schedule request explicitly or implicitly specifies one or more criteria to limit the duration, the scope, or other parameters of schedule 30 and its constituent items 34. The criteria, whether specified according to the schedule request or determined in another manner, may be stored for future reference so that user 14 need not specify the criteria each time user 14 requests a schedule 30. Of course, user 14 would preferably be able to change one or more stored criteria according to particular needs.

At step 102, scheduling engine 18 receives information concerning one or more schedule items 34 from one or more applications 12. This information may include the time, date, name, number, description, type, category, or any other suitable information concerning items 34. Scheduling engine 18 may store the information received after a preceding schedule request and use the stored information in responding to the current schedule request. In the alternative, scheduling engine 18 may process information for items 34 substantially continuously such that previously generated schedules 30 may be updated substantially continuously in substantially real time. At step 104, scheduling engine 18 determines whether the items 34 satisfy the specified criteria and are eligible for incorporation into schedule 30. For example, an item 34 whose date lies outside the one or more time periods 32 specified for schedule 30 will not be incorporated. Such non-complying items 34 are discarded, stored, or otherwise eliminated at step 106. The scheduling engine 18 preferably stores non-complying items 34 for incorporation into other schedules 30 having different criteria that these items 34 may satisfy. Such other schedules 30 might include a new schedule 30, a previously generated schedule 30 that has been modified, or any other suitable schedule 30.

At step 108, scheduling engine 18 incorporates the complying items 34 into the appropriate cells 38 of schedule 30 and at the appropriate locations 44 within these cells 38. In one embodiment, as described more fully above, location 44 for item 34 may be specified according to a percentage 54 of the horizontal width 42 of cell 38, based on time and/or date information received from one or more applications 12. However, the present invention contemplates positioning items 34 in cells 38 in any suitable manner using any suitable frame of reference. At step 110, scheduling engine 18 may generate links 56 for retrieval of images 58 associated with the items 34 and, at step 112, may generate alt tags 40 for the items 34. As described above, scheduling engine 18 may incorporate information received from one or more applications 12, such as a purchase order number, into images 58, alt tags 40, or both images 58 and alt tags 40.

At step 114, rendering engine 20 renders schedule 30 according to the content generated at scheduling engine 18. In one embodiment, this may involve formatting an HTML page incorporating schedule 30 that is suitable for display at a web browser or other HTML-enabled front end. At step 116, web server 22 communicates schedule 30 to user 14, where user 14 may view schedule 30 and respond as appropriate to any item 34 contained therein. If the user 14 wishes to obtain another schedule 30 at step 118, either in the form of a new schedule 30, a modified version of the previously generated schedule (perhaps expanded or contracted with respect to duration, categories, or other parameters), or a refreshed schedule 30 incorporating items 34 processed at scheduling engine 18 subsequent to generation of the previous schedule 30, the method returns to step 100, where user 14 communicates another schedule request to web server 22. As noted above, system 10 may update the schedule 30 substantially continuously in other embodiments, such that successive schedule requests may be unnecessary. If another schedule is not desired at step 118, the method ends.

Although the present invention has been described with several embodiments, a plethora of changes, substitutions, variations, alterations, and modifications may be suggested to one skilled in the art, and it is intended that the invention encompass all such changes, substitutions, variations, alterations, and modifications as fall within the spirit and scope of the appended claims.

1-30. (canceled)

31. An application-driven scheduling system, comprising:
a scheduling engine for generating a schedule, the scheduling engine operable to:
receive at least one schedule item and associated time information from at least one application, the time information comprising at least a duration and a required time period for the item;
access one or more schedule criteria comprising at least a time period schedule criterion specifying a time period spanning a plurality of schedule time slots and a plurality of user-specified categories to which the schedule should be limited;
determine whether the time information comprising the required time period for the item satisfies the schedule criteria comprising the time period schedule criterion by comparing at least the required time period for the received item with the time period specified in the time period schedule criterion;
determine whether the item corresponds to one of the user-specified categories to which the schedule should be limited;
if the time information comprising the required time period for the received item satisfies the schedule criteria comprising the time period schedule criterion in that the required time period for the received item falls within the time period specified in the time period schedule criterion and the item corresponds to one of the user-specified categories, attempt to determine a location for the item within a schedule according to the time information and the category to which the item corresponds;
if the time information comprising the required time period for the received item does not satisfy the schedule criteria comprising the time period schedule criterion in that the required time period for the received item falls outside the time period specified in the time period schedule criterion or if the item does not correspond to one of the user-specified categories, refrain from attempting to determine a location for the item within the schedule; and
generate the schedule containing the item if the time information comprising the required time period for the received item satisfies the schedule criteria and the item corresponds to one of the user-specified categories at least in part by assigning the item to the corresponding user-specified category and to one of the plurality of time slots within the time period specified in the time period schedule criterion, the time slot having a duration equal to the duration for the item; and
a rendering engine operable to render the schedule for display to at least one user.

32. The system of claim 31, wherein the schedule comprises one or more cells and the location for the item is within a particular cell, the scheduling engine operable to determine the cell for the item and determine the location for the item within the cell according to the time information.

33. The system of claim 32, wherein the location for the item within the cell is determined according to a percentage of the width of the cell corresponding to the time information.

34. The system of claim 32, wherein the schedule comprises, for each time slot, a cell associated with each of the user-specified categories and wherein the scheduling engine is operable to determine the cell for the item based on the user-specified category that corresponds with the item.

35. The system of claim 31, wherein the scheduling engine is further operable to generate a link to an image associated with the item, the rendering engine operable to use the link to retrieve the image for display at the location for the item.

36. The system of claim 31, wherein the scheduling engine is further operable to generate an alt tag for the item, the alt tag comprising information concerning the item for display in response to the user selecting an image associated with the item.

37. The system of claim 36, wherein the alt tag is an HTML alt tag for displaying the information regarding the item.

38. A method of generating a schedule in an application-driven scheduling system, the method comprising:
receiving at least one schedule item and associated time information from at least one application, the time information comprising at least a duration and a required time period for the item;
accessing one or more schedule criteria comprising at least a time period schedule criterion specifying a time period spanning a plurality of schedule time slots and a plurality of user-specified categories to which the schedule should be limited;
determining whether the time information comprising the required time period for the item satisfies the schedule criteria comprising the time period schedule criterion by comparing at least the required time period for the received item with the time period specified in the time period schedule criterion;
determine whether the item corresponds to one of the user-specified categories to which the schedule should be limited;
if the time information comprising the required time period for the received item satisfies the schedule criteria comprising the time period schedule criterion in that the required time period for the received item falls within the time period specified in the time period schedule criterion and the item corresponds to one of the user-specified categories, attempting to determine a location for the item within a schedule according to the time information and the category to which the item corresponds;
if the time information comprising the required time period for the received item does not satisfy the schedule criteria comprising the time period schedule criterion in that the required time period for the received item falls outside the time period specified in the time period schedule criterion or if the item does not correspond to one of the user-specified categories, refraining from attempting to determine a location for the item within the schedule;
generating the schedule containing the item if the time information comprising the required time period for the received item satisfies the schedule criteria and the item corresponds to one of the user-specified categories at least in part by assigning the item to the corresponding user-specified category and to one of the plurality of time slots within the time period specified in the time period schedule criterion, the time slot having a duration equal to the duration for the item; and
rendering the schedule for display to at least one user.

39. The method of claim 38, wherein the schedule comprises one or more cells and the location for the item is within a particular cell, determining the location comprising determining the cell for the item and determining the location for the item within the cell according to the time information.

40. The method of claim 39, wherein the location for the item within the cell is determined according to a percentage of the width of the cell corresponding to the time information.

41. The method of claim 39, wherein the schedule comprises, for each time slot, a cell associated with each of the user-specified categories, and wherein the method further comprising determining the cell for the item based on the user-specified category that corresponds with the item.

42. The method of claim 38, further comprising:
generating a link to an image associated with the item; and
using the link to retrieve the image for display at the location for the item.

43. The method of claim 38, further comprising generating an alt tag for the item, the alt tag comprising information concerning the item for display in response to the user selecting an image associated with the item.

44. The method of claim 43, wherein the alt tag is an HTML alt tag for displaying the information regarding the item.

45. Software for generating an application-driven schedule, the software being embodied in a computer-readable medium and operable to:
receive at least one schedule item and associated time information from at least one application, the time information comprising at least a duration and a required time period for the item;
access one or more schedule criteria comprising at least a time period schedule criterion specifying a time period spanning a plurality of schedule time slots slots and a plurality of user-specified categories to which the schedule should be limited;
determine whether the time information comprising the required time period for the item satisfies the schedule criteria comprising the time period schedule criterion by comparing at least the required time period for the received item with the time period specified in the time period schedule criterion;
determine whether the item corresponds to one of the user-specified categories to which the schedule should be limited;
if the time information comprising the required time period for the received item satisfies the schedule criteria comprising the time period schedule criterion in that the required time period for the received item falls within the time period specified in the time period schedule criterion and the item corresponds to one of the user-specified categories, attempt to determine a location for the item within a schedule according to the time information and the category to which the item corresponds;
if the time information comprising the required time period for the received item does not satisfy the schedule criteria comprising the time period schedule criterion in that the required time period for the received item falls outside the time period specified in the time period schedule criterion or if the item does not correspond to one of the user-specified categories, refrain from attempting to determine a location for the item within the schedule;
generate the schedule containing the item if the time information comprising the required time period for the received item satisfies the schedule criteria and the item corresponds to one of the user-specified categories at least in part by assigning the item to the corresponding user-specified category and to one of the plurality of time slots within the time period specified in the time period schedule criterion, the time slot having a duration equal to the duration for the item; and
render the schedule for display to at least one user.

46. The software of claim 45, wherein the schedule comprises one or more cells and the location for the item is within a particular cell, and the software is operable to determine the cell for the item and determine the location for the item within the cell according to the time information.

47. The software of claim 46, wherein the location for the item within the cell is determined according to a percentage of the width of the cell corresponding to the time information.

48. The software of claim 46, wherein the schedule comprises, for each time slot, a cell associated with each of the user-specified categories and wherein the software operable to determine the cell for the item based on the user-specified category that corresponds with the item.

49. The software of claim 45, further operable to generate a link to an image associated with the item and to use the link to retrieve the image for display at the location for the item.

50. The software of claim 45, further operable to generate an HTML alt tag for the item, the alt tag comprising information concerning the item for display in response to the user selecting an image associated with the item, wherein the HTML alt tag is for displaying the information regarding the item.
